(19) United States
(12) Patent Application Publication
(10) Pub. No.: US 2004/0201495 A1
(43) Pub. Date: Oct. 14, 2004

(54) Digital coded horizontal overhead obstacles warning system for vehicles

(76) Inventors: Hee Chuan Lim, Edison, NJ (US); Yew Fong Hor, Edison, NJ (US); Julian S. Tan, Iselin, NJ (US); Eugenio Santos, Iselin, NJ (US)

Correspondence Address: Mr. Walter J. Tencza Jr., Suite 3, 10 Station Place, Metuchen, NJ, 08840, US

(21) Appl. No.: 10/412,198

(22) Filed: Apr. 11, 2003

(51) Int. Cl. G08G 1/09

(52) U.S. Cl. 340/905

(57) ABSTRACT

A digital coded signal for horizontal overhead obstacles warning system comprises of an active transmitter mounted in the vicinity of the said horizontal overhead obstacles and a receiver unit in each automobile vehicle. The transmitter transmits a string of digitally encoded signal periodically with a brief interval in between e.g. millisecond range, where the digital code corresponds, to the road name leading to the obstacle or obstacles and the corresponding height. The string of the digital signal will be password protected and encoded with a specific number of start bits, end bits, and parity. The receiver units, which are self contained receive and decode the signal and then display the information on the front panel, and also projects it on the vehicle's wind shield at dim light condition. In order to overcome electrical engine noise and other stray RF frequencies, the receiver includes a band pass filter and a pulse width decoder. A dynamic memory holds the data on the colored back lighting LCD display until a different coded signal is received. This would gives out a visually flashing indicator according to the transmitter refresh/sending rate to alert the vehicle operator, besides the audio warning that can be activated or turned off. All of the approaching vehicle will receive the same information and hence the visual indication substantially simultaneously.

### FIELD OF THE INVENTION

This invention relates to providing warnings regarding obstacles, such as low bridges, to vehicles, such as semi-truck trailers, cargo containers, over size vehicles, and marine vehicles.

### BACKGROUND OF THE INVENTION

When a low overpass bridge or any other obstacles are situated along the direction of travel of a vehicle, such as a truck, usually a sign or post is erected approximately ten to thirty feet away from the overpass bridge. The sign may indicate the bridge height and maximum allowable clearance. The sign may be supplemented by height posting on the bridge. However an operator of a truck, for example, may fails to realize that his or her vehicle's maximum height is greater than the clearance height for the overpass bridge. The operator's potential error may result in collisions, pileups, and traffic backups.

The existing system of signs or postings relies on an operator of a vehicle actually seeing the signs or postings at a time when the operator is concentrating completely on operating the vehicle, especially when the operator is new to the environment and the surroundings. Because of the nature of the driving condition of larger than normal vehicles, such as trucks, it is often difficult for the operator either to see the existing signs or postings and therefore difficult to make the connection or to react in sufficient time to the signs or postings.

One of the major disadvantages of the existing signs and postings is that, due to proximity to or distance from the signs or postings when the vehicle is in motion; dust, smoke, snow, and fog on the road, or glare of sunlight and xenon “high beam” headlights of other vehicles at nighttime shining into the eyes of the drivers, as well as the need to concentrate on driving especially when lost and new to a route, operators cannot be expected to notice the caution signs or postings. Moreover, trees and branches and their shadows may be blocking the view of the signs or postings, making it harder for the operator to see the signs or postings in time to avoid a collision with the bridge.

Current global positioning satellite (GPS) system databases and paper maps are not complete and do not provide detailed information of every low overhead bridge overpass found in the suburbs and in the inner city. Without this, “human judgment” would be again used to navigate through the bridge overpasses encountered.

When a vehicle, such as a truck collides with the underside of a bridge overpass or gets stuck under a bridge over pass, often the information is not passed along quick enough to warn other semi truck operators from taking the route and this is highly dangerous as the semi truck operator will often steer into the very same wrecked vehicle.

Furthermore, the two existing physical systems, that are the postings and signs located in the vicinity of the bridge overpass, are not always erected and made available. These postings and signs are not always located at the exact same distance away and are not always large enough to be discernible. Some drivers will rely on one or the other, but not both. In addition, one operator's view may often be blocked by another semi truck when traveling along the same route. In either case, if an operator reacts to the bridge height sign or posting by stopping, a closely-following vehicle may not see the sign or posting in time and may rear end the stopped vehicle. Such rear end collisions are costly and extremely dangerous. Collisions between vehicles, such as trucks, and bridge overpasses may result in expensive and time-consuming bridge repairs, too.

Because of accidents with the low overhead obstacle or bridge of this type that occurs regularly, truck operators and responsible bridge authorities, such as train authorities, local, municipal, or township authorities, have experienced sharply increased costs for insurance and bridge repairs, and other commuters experience considerable delays in the roadway due to “clean up”.

In short, the existing caution alerting systems for vehicles lack the ability to signal a strong caution warning to all the “oversize” vehicle, and cannot ensure that the operator will be alerted of the bridge height and successfully pass under the bridge or bridge overpass.

U.S. Pat. No. 5,389,912 to Arvin, which is incorporated by reference herein, provides a “Truck Clearance Anti-Collision Device”. Arvin discloses an anti-collision device 50 and a ultrasonic wave transducer 52 mounted to a vehicle 10. (Arvin, col. 5, Ins. 49-68) A driver of the vehicle 10 slows down until the transducer 52 is located below a bridge B. (Id.) A reading will be received when the transducer 52 is below the bridge B to indicate whether the bridge height is too low to allow the vehicle 10 to pass underneath. (Id.) If the height is too low, the driver will have to back up and find another route or entry point. (Id.).

Arvin does not provide a desirable device since the driver of a vehicle has to be located under the bridge to get a reading, making it too late to stop or making it necessary to back up.

### SUMMARY OF THE INVENTION

The present invention in one or more embodiments provides a horizontal overhead obstacle clearance warning system. A digital signal system can be used for communicating information such as height and condition of a bridge. The information may travel from the obstacle to the driver or operator of a vehicle, such as a truck, automobile or a marine vehicle.

One objective of the present invention in one or more embodiments is to provide an additional roadway hazardous condition alerting system, which avoids the above-mentioned drawbacks of existing systems and provides advantages not included in the prior art.

It is also the intention of this invention to provide a roadway hazardous condition warning system in which an alerting display indicator is positioned in plain view of every operator and will let every operator approaching the low overhead obstacle, such as an overhead bridge or bridge overpass and railway track know simultaneously when there is a risk of collision with the vehicle, or its cargo.

It is a still further objective of this invention to provide such a warning system that can act as witness elements for a truck cargo and bridge collision investigation with its built-in back up memory of all the bridges that the vehicle has traveled on its route.

Another objective of this invention is to provide an alerting system, which will hopefully eliminate the dangerous practice of “eye-in” to estimate the height of the bridge while traveling.

It is yet a further objective of this invention to provide a roadway hazardous condition alerting system which alerts an operator under all adverse conditions, i.e., when dust on a dirt road, or sunlight on dirt, asphalt, water as in rain, snow, or fog making it impossible to see a posted bridge height sign.

It is yet another objective of this invention to provide a reliable alerting system, which will operate even in the presence of severe electrical engine noise and interference, that is typical of automotive operation, wireless cellular phones and global positioning satellite (GPS) system.

It is still another objective of this invention to provide a roadway hazardous condition alerting system, which is effective in both daytime and night and seasonal conditions.

Another objective is to provide one or more embodiments that are capable of detecting and warning of a potential collision condition two to five miles away from an obstacle or bridge so that an operator of a vehicle may be able to take notice and avoid the obstacle or bridge. The avoidance of the obstacle or bridge may avoid expensive and time-consuming bridge repairs, cargo delivery delays, traffic inconvenience, and other losses.

A transmitter can be connected with an electrical supply for a streetlight or lamp posting system or on a billboard advertisement sign system. Another method of supplying electrical power for continuous operation of the transmitter would be the use of a “military grade” long life alkaline battery pack used in most NASA (National Aeronautics and Space Administration) high altitude scientific experiment, that would typically last for 8500 hours, and have large temperature fluctuation tolerance.

The transmitter may transmit a radio frequency (“RF”) carrier, typically at a frequency of about 500 Megahertz, as used in a commercially available family radio services (FRS) walkie-talkie, such as “Audiovox” (Trademarked) made by Motorola (Trademarked), which is modulated continuously to indicate the presence of obstacle information and this is radiated by means of an antenna or antenna system over a range of a two to -five miles radius depending on the surrounding vegetation that encompasses the bridge.

The present invention in one or more embodiments may be comprised of a plurality of receiver units. Each of the receiver units may have a means for mounting the particular receiver unit in an associated vehicle dashboard or inside ceiling of the said vehicle, an antenna to receive a signal transmitted by the transmitter, a digital signal processing processor to demodulate the signal carrier, a decoder to decode a signal to produce the obstacle information and its corresponding warning indications by comparing the vehicle height with the received bridge height, and a front panel to display the information that is clearly visible to all the drivers approaching the same bridge from any direction. A colored backlighting LCD display panel may be provided which would light up to indicate one of the following; “clear” (or “passable”), or otherwise “danger” (or “impassable”) condition, in response to the results of the comparison of the vehicle height with the received bridge height.

The receiver unit can be mounted on a vehicle dashboard. “Mounted” may include using tape or other adhesive to mount the receiver unit to the dashboard or screwing, tying, or nailing the receiver unit to the dashboard so that the receiver unit can be seen by an operator.

It is encompassed in the present invention that the signals, sent out by the transmitter can be password coded and can be decoded at a particular receiver unit. Consequently a specific code can be used to activate the receiver. The receiver unit in a particular vehicle may be coupled to a vehicle ignition system of the vehicle. The digitally coded information signal prevents stray or spurious signals or RF noise or commercial sabotage from accidentally miss-indicating a caution. Without appropriate signal encoding and without decoding circuitry in the receivers, the high amount of electrical noise from vehicle and radar or microwaves interferences from emergency vehicles could prevent effective operation.

The present invention in one or more embodiments provides an apparatus comprising a receiver unit comprised of a processor and an indicator. The receiver unit can receive a signal from a transmitter; wherein the signal includes information about an obstacle on a transportation route. The processor may obtain from the signal the information about the obstacle, and the processor may cause the indicator to provide an indication relating to the information about the obstacle. The obstacle may be bridge overpass and the information provided may be the lowest height of the bridge overpass. The indicator may be a visual display and/or an audible alarm. The receiver unit may include a memory in which is stored a maximum height of a vehicle in which the receiver unit is located.

The visual display may display the maximum height of the vehicle. The receiver unit may includes a keypad, which can be used to enter the maximum height of a vehicle in which the receiver unit is located. The receiver unit may include a memory in which is stored a maximum height of a vehicle in which the receiver unit is located. The information provided about the obstacle may include the location of the obstacle. The location of the obstacle may include a street where the obstacle is located.

The signal from the transmitter may be comprised of a string of digital bits. The string of digital bits may include a string of start bits, a string of password bits, a string of location bits specifying the location of the obstacle, and a string of stop bits. The receiver unit may include means for mounting the receiving unit onto a dashboard or interior ceiling of a vehicle.

The processor may compares a maximum height of a vehicle with the height of a bridge overpass and the processor may causes the indicator to provide an indication when the maximum height of the vehicle is greater than the height of the bridge overpass.

The receiver unit may includes a demodulator. The signal received by the receiver unit may be a modulated carrier signal and the demodulator demodulates the signal. The receiver unit may include a decoder, and the decoder may decode the signal with the use of a password.

The present invention in one or more embodiments includes a method comprising obtaining a signal from a transmitter, wherein the signal includes information about an obstacle on a transportation route. The method may be further comprised of causing an indicator to provide an indication relating to the information about the obstacle.

Additional advantages and usefulness of the presented invention will become more apparent from the following detailed description with the help of the drawings.

### BRIEF DESCRIPTION OF THE DRAWINGS

FIG. 1 is a simplified diagram showing a straight roadway course at which a system in accordance with an embodiment of the present invention is employed;

FIG. 2 is a simplified diagram showing a “Y” split roadway course at which the an embodiment of the present invention is employed;

FIG. 3 is a front view a receiver front panel according to an embodiment of the present invention;

FIG. 4 is a front view of a transmitter front panel according to an embodiment of this invention;

FIG. 5 is a diagram showing details of circuitry of a receiver in accordance with an embodiment of the present invention;

FIG. 6 is a diagram showing details of circuitry of a transmitter in accordance with an embodiment of the present invention;

FIG. 7 is a flowchart of a warning system method employed with embodiments of the present invention;

FIG. 8 is a diagram of a digital coded signal employed with embodiments of the present invention; and

FIG. 9 shows the top view of a portion of a semi-truck mounted with the receiver unit of FIG. 3.

### DETAILED DESCRIPTION OF THE DRAWINGS

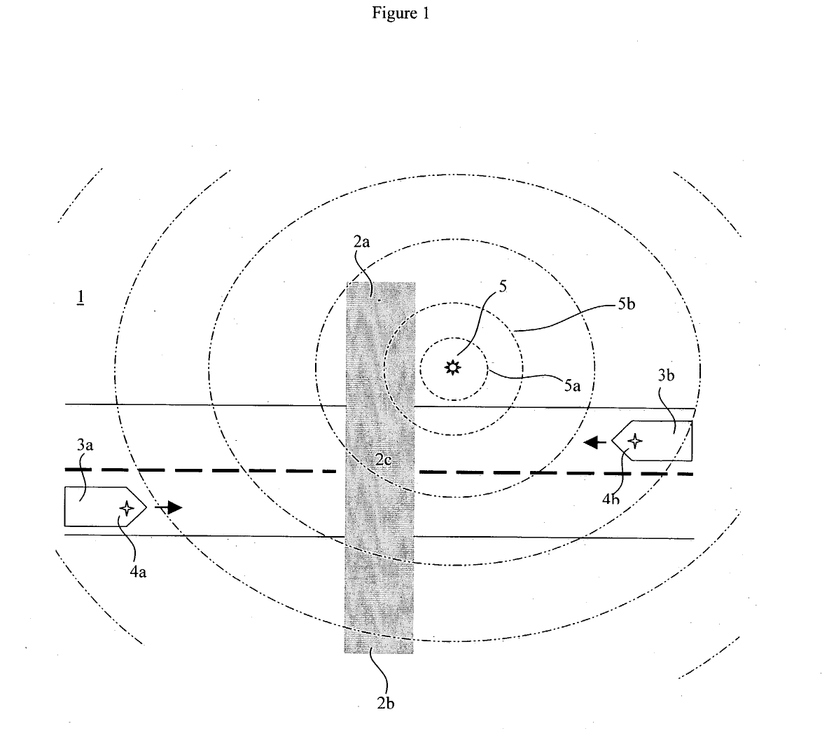

FIG. 1 is a simplified diagram showing a straight bi-directional roadway 1 leading to a low overhead bridge 2. Also, depicted in FIG. 1 are vehicles 3a and 3b traveling towards the low overhead bridge 2. The vehicles 3a and 3b may each be trucks or semi-trucks. Inside vehicles 3a and 3b are receiver units 4a and 4b respectively mounted on top of a vehicle dashboard in each of the vehicles 3a and 3b. The receiver unit's 4a and 4b are powered by dc electrical power supply systems usually found in a vehicle or automobile, which are in vehicles 3a and 3b respectively, with an additional rechargeable built-in battery pack that acts as an emergency back-up power source. The receiver unit's 4a and 4b can also be mounted on the inner ceilings of the vehicles 3a and 3b respectively, if needed due to space restriction or any other reason.

Also, shown in FIG. 1 is a transmitter 5. The transmitter 5 may be positioned in the vicinity of either a side 2a or a side 2b of the bridge or bridge overpass 2, but preferably on top 2c of the bridge 2 to give a “clearer” dynamic radio frequency (RF) broadcast range. The transmitter 5 can be battery powered by a long life alkaline type source or sources or can be coupled to an external power source; such as a streetlight lamppost or any billboard advertisement power supply. The transmitter 5 is also enclosed with an environmental protective casing to prolong its life to the seasonal conditions and changes. The higher clearance ground would enable the encoded signals to travel further from the transmitter 5, to reach individual vehicles that are equipped with the receiver unit 4 of the location or road name leading to and height information of the bridge 2. The circularly dotted lines, such as 5a and 5b, are the illustration of the encoded digital signals propagating spherically outward from the transmitter 5. As mentioned before, the signals transmitted by the transmitter 5 signals would typically be transmitted or would encompass a range of a two to five miles radius around the bridge 2 and would be able to deliver information to the receiver units 4a and 4b that is active as long as the vehicles 3a and 3b, respectively are in motion towards the overhead bridge and due to the fact that the vehicles receiver is being coupled to the vehicle's electrical ignition systems of vehicles 3a and 3b.

As mentioned above, it is often difficult for the drivers of vehicles 3a and 3b to see the posted signs on the sides of the road or on top of the bridge 2 due to dust, glare, an obstructing other oversize vehicle, or for other reasons. Because of this it often occurs that a driver is not alerted to a caution sign or posting in time to avoid a mishap that results in damage to the vehicle or cargo that it is carrying, and could result in injury to the driver.

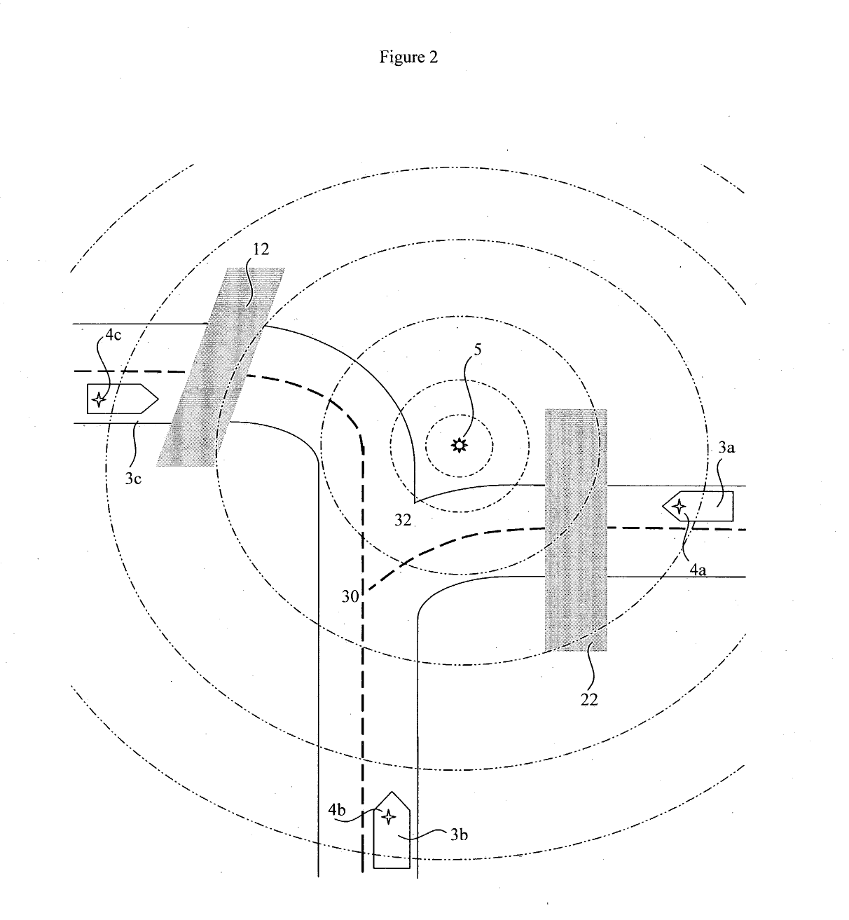

FIG. 2 shows, the top view layout of a common Y intersection 30 with two low overhead bridges 12 and 22 located left and right of a fork 32 within a close vicinity of two to three miles radius apart. Since the transmitter 5, in accordance with an embodiment of the present invention, is capable of transmitting the bridge 12 and 22 information across a five miles radial range, only one transmitter 5 could be employed and strategically located for that purpose.

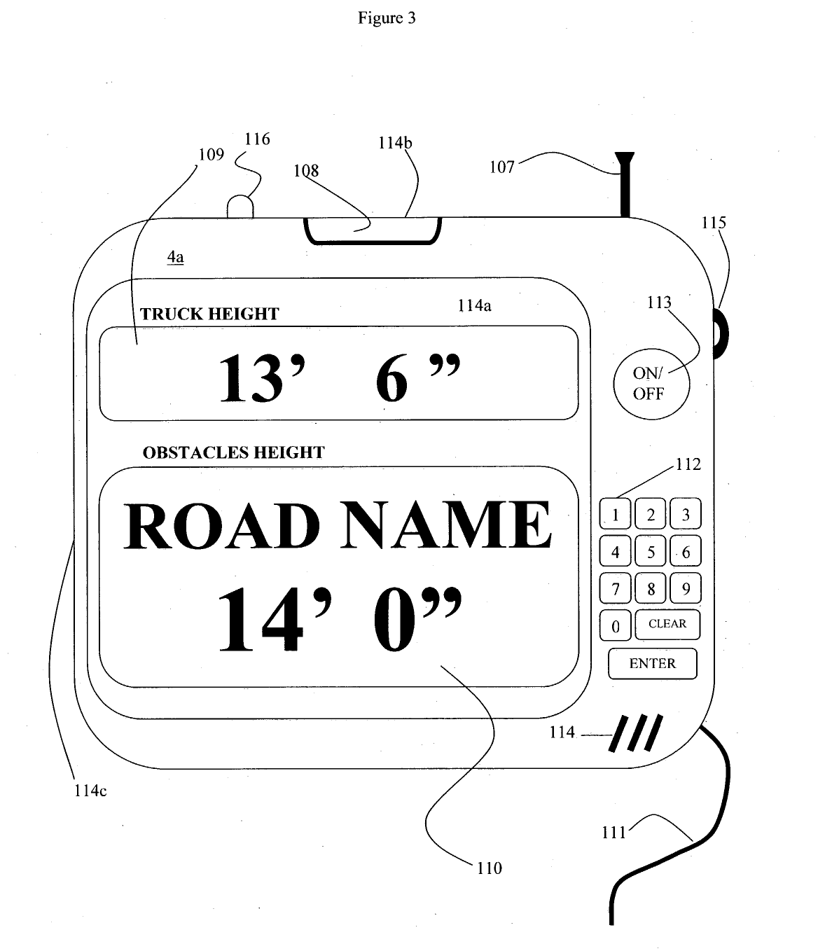

FIG. 3 shows a front panel 114a of the receiver unit 4a. The receiver unit 4a includes an antenna 7, situated at the top of an encasement 114b. The antenna 107 receives and or senses a signal from the transmitter 5. The signal from the transmitter 5 may be a modulated signal and may provide information about a bridge or bridge overpass such as bridge or bridge overpasses 2, 12, and 22. The antenna 7 can be a short flexible whip antenna extending from the encasement 114b. For the projection of the information on a windshield of a vehicle, such as vehicle 3a, a translucent projector port 108 may also be located on the top center of the encasement 114b at an approximately 5° (five degree) tilting angle. (no need)The operator has the options of turning on or off the image projection of the information received by the receiver from the transmitter by actuating a projection on/off switch 116. Two large colored backlighting liquid crystal (“LCD”) displays 109 and 110 dominate the front panel 1 14a of the receiver unit 4a. The LCD display 109, shown near the top of the front panel 114a would be used to display the vehicle 3a maximum height while the bottom LCD display 110 would display the decoded bridge information signals received from a transmitter 5, such as signals received from transmitter 5 concerning bridges 2, 12, or 22. The vehicle's maximum height can be typed or entered in by an operator via a keypad 112 at the beginning of each the trip or when a new cargo is mounted to the vehicle, such as vehicle 3a. When a bridge or bridge overpass height is detected which is lower than the vehicle, such as vehicle 3a, maximum height, the colored backlighting LCD display 110 will light up and blink or strobe on and off, to notify the driver. In addition to that the receiver unit may provide an audio warning that the vehicle 3a is not going to be able to pass underneath the bridge overpass or bridge such as bridge or bridge overpass 2, through a built in speaker 114. The audio strength is controllable by the driver using a volume control knob 115 located on the side 114c of the receiver unit 4a. The receiver unit 4a can be powered by a vehicle electrical power system of the vehicle 3a, such as through a cigarette lighter socket by an external cable 111 disposed on the rear of the encasement 114a. In case of power failure, the receiver unit 4a may have a built-in rechargeable backup battery pack, not shown, inside the encasement 114a to ensure functionality.

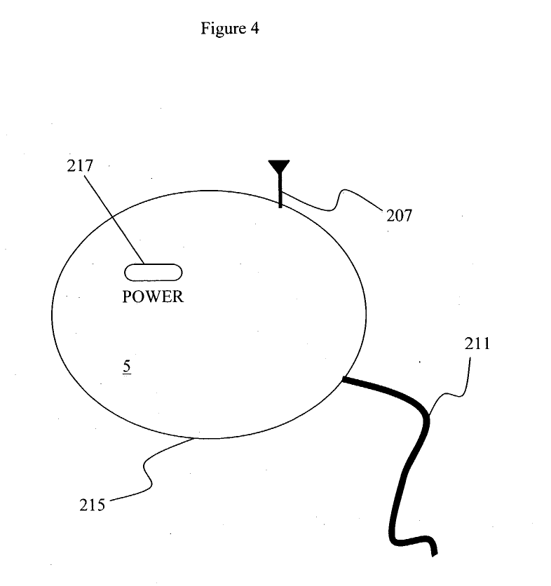

FIG. 4 shows an encasement 215 for the transmitter 5. The encasement 215 may be an environmental proof encasement, described later. On top of the encasement 215 of the transmitter unit 5 is an antenna 207 that broadcasts and transmits a coded signal or signals including information about a bridge or bridge overpass, such as bridge or bridge overpasses 2, 12, or 22, or information about some other obstacles. The signals transmitted by antenna 207 typically spread spherically outwards away from antenna 207. A small low power consumption Light Emitting Diode (LED) 217 can be installed on the encasement 215 or front panel of the transmitter 5 to indicate that the transmitter 5 is operational and active. The transmitter 5 can be powered by the previously described battery pack or by an external power source via a power cord 211 disposed on the rear of the encasement 215.

A housing for the encasement 215 for the transmitter 5 and a housing for the encasement 114a for the receiver unit 4a may be a housing of a type typically manufactured by POLYCASE (trademarked), e.g. AG (manufacturer series id) series or JB series enclosures that is Underwriters Laboratories/Canadian Standards Association (UL/CSA) approved flame retardant Acrylonitrile Butadiene Styrene (ABS) plastic with Silicon water proof sealant around the tongue and groove of the construction..

The receiver unit 4a and the transmitter 5 can be rather light in weight, weighing only one or two ounces. The receiver unit 4a can be dimensioned to be only about three inches in height and width and about two inches in depth. The receiver unit 4a can be held in place by a quick-mounting strap, and the strap can be of commercially available Velcro (Trademarked) or a similar pile type releasable attaching material. The entire receiver unit 4a may be adjustable on the dashboard of the vehicle so that the LCD displays are always in plain view of the driver.

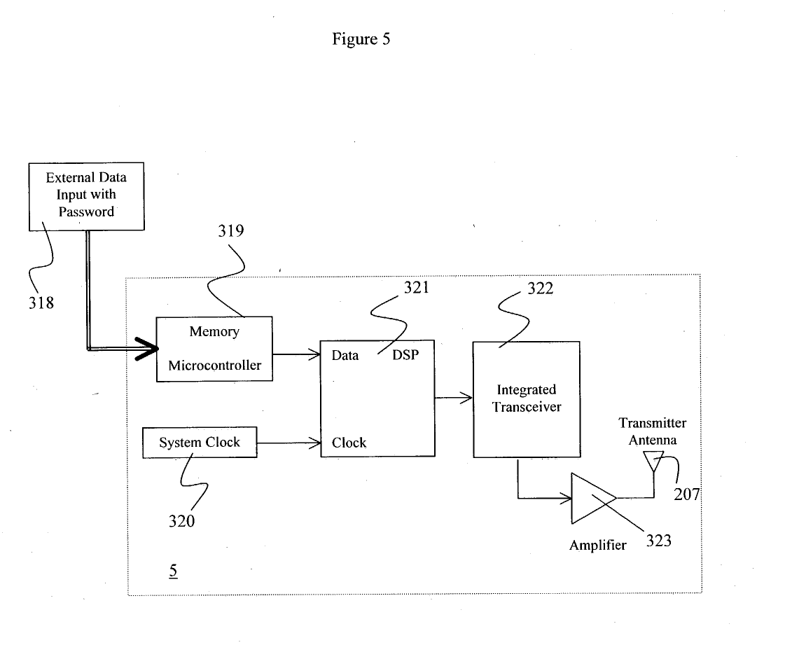

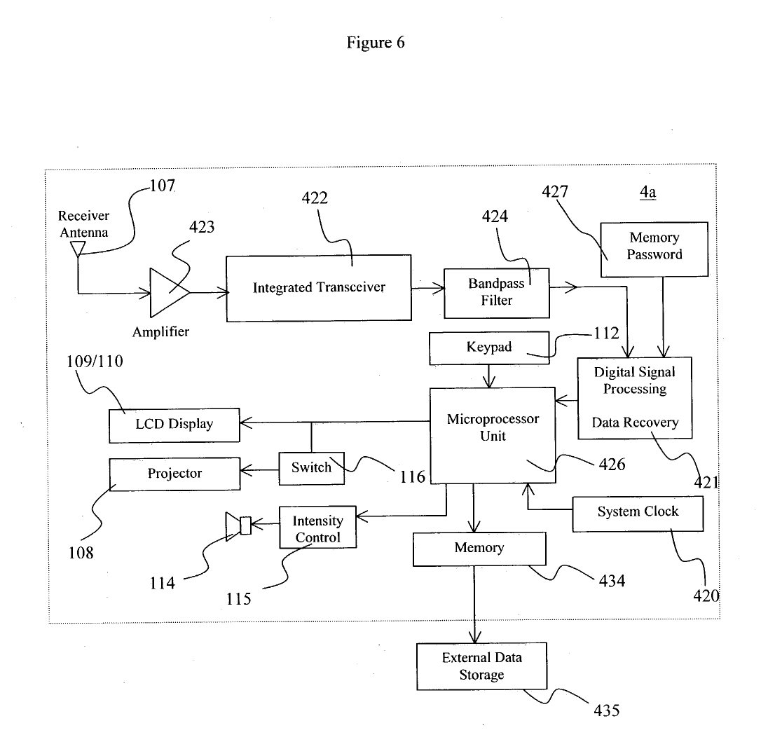

The transmitter 5 typically includes the circuitry shown by the diagram in FIG. 5. The receiver unit 4a (or receiver units 4b or 4c of FIGS. 1 and/or 2) has the basic digital circuitry as shown by FIG. 6.

As shown in FIG. 5, the transmitter 5 may be comprised of a memory and microcontroller 319, a system clock 320, a digital signal processor (DSP) 321, an integrated transceiver 322, an amplifier 323, and a transmitter antenna 207. The transmitter 5 can be preprogrammed either on-site at a bridge or obstacle, such as bridge 2 in FIG. 1, or prior to being installed at the bridge, such as in a laboratory or in a factory. The transmitter 5 can be programmed with information relating to a bridge, obstacle, or bridge overpass, such as a street or road name where the bridge is located or leading to the bridge 2, a lowest height of the bridge 2, and information concerning whether the bridge 2 is slanted or not perfectly horizontal.

An operator of the transmitter 5 can enter an external data input with a password 318 into the memory and microcontroller 319. The external data input with a password 318 may be entered into the memory and microcontroller 319 via a serial or parallel cable or wireless communication. The system clock 320 can be used to synchronize the digital signal processor 321 for accurate digital signal timing. A typical clock frequency used for the system clock 320, would be twenty-five Megahertz in order to drive a DSP 321, which may be for example a PROCOM (Trademarked) digital signal processor (DSP), model #MC68340PV25E 32-bit 25 Megahertz Microprocessor Unit (MPU).

Data received by the DSP 321, is next passed to the integrated transceiver 322. The integrated transceiver 322 filters data with a radio frequency (“RF”) filter to reduce any signal error and modulates the data by means of a modulator. The data is then amplified by the amplifier 323. The amplifier 323 may be a low current Microwave and Millimeter-Wave Integrated Circuits (MMICS) op-amp 324. Typical integrated transceiver 322 to be employed would be the XE1201A low power Ultra High Frequency (UHF) transceiver, with 300-500 Mega Hz frequency range. The antenna 207 of the transmitter 5 then broadcasts the data from the amplifier 323. Only the transmitting portion of the integrated transceiver 322 is typically utilized, and not the receiver portion, to eliminate commercial sabotage from changing the password and/or bridge information by means of wireless hacking, since the transmitter 5 would be mounted at a normally inaccessible altitude that can only be reached for maintenance by a specialized maintenance crane.

FIG. 6 shows electronic components of the receiver unit 4a. The electronic components include receiver antenna 107, system clock 420, digital signal processing and data recovery unit 421, system amplifier 423, integrated transceiver 422, bandpass filter 424, keypad 112, microprocessor unit 426, memory, liquid crystal display 109, projector 108, switch 116, speaker 114, intensity control 115, memory 434, and external data storage 435.

The antenna 107 receives as a received signal, the transmitted and typically modulated signal from the transmitter 5 and feeds the received signal to the amplifier 423. The amplifier 423 is typically an operational—amplifier which boosts the signal received from the transmitter 5. The signal is next passed to the integrated transceiver 422 for demodulation and radio frequency (RF) filtering. The signal is next noise filtered by means of the bandpass filter 424.

An operator of a vehicle, such as vehicle 3a, having a receiver unit 4a, can then input a password or memory password 427 into DSP 421. The password 427 allows the operator of vehicle 3a to decode the signal received from the transmitter 5 and thereby obtain information about bridges, bridge overpasses, and obstacles, such as bridge 2 of FIG. 1. The DSP 421 may be a S6264-20S, 8K×8, 20 nanosecond, standard power, twenty-eight pin, Dual-In-line Package (DIP)

The circuitry for the receiver 4a may also include the keypad 112, as previously also shown in FIG. 3, 425 for the operator to enter a maximum height for the vehicle 3a into the microprocessor unit 426). The microprocessor unit 426 may be a. PIC16C74B-20/P, Multipoint Control Unit (MCU), Complementary Metal Oxide Semiconductor (CMOS) 20 Megahertz, 4K Erasable Programmable Read-Only Memory (EPROM), Dual-In-Line Package (DIP). The microprocessor unit 426 may implement a collision warning method. The entered vehicle's maximum height may be promptly displayed on the Liquid Crystal displays (LCD) display 109), shown under the designation “Truck Height” in FIG. 3 via the microprocessor unit 426.

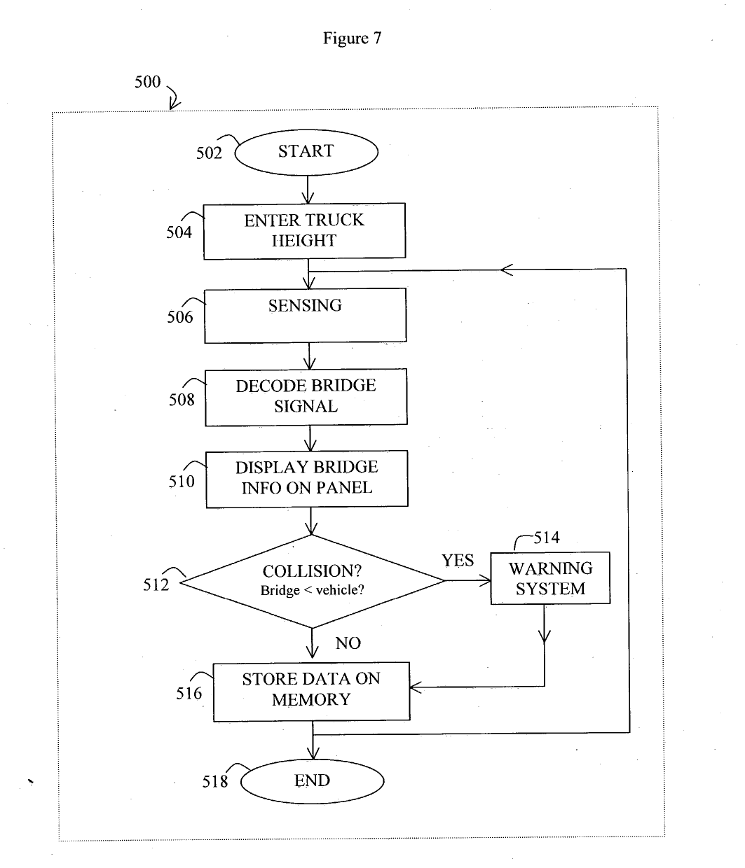

The logic of the collision warning method may be as shown in a flow chart 500 in FIG. 7. The method starts at step 502. At step 504, an operator of a vehicle, such as vehicle 3a, may enter the vehicle height, such as truck height, into the keypad 112 shown in FIG. 3 and 6. At step 506 the receiver unit 4a may sense or receive a signal sent by the transmitter 5. At step 508, the receiver unit 4a may decode the signal sent by the transmitter 5. At step 510, bridge information retrieved from the signal sent by the transmitter 5, such as bridge or bridge overpass height information, may be displayed on the display 110 of the panel 1 14a as shown by FIG. 3. At step 512, the microprocessor 426 may determine whether the maximum height of the vehicle 3a is less than the lowest height of the bridge or bridge overpass 2, i.e. will the vehicle 3a be able to safely pass under the bridge or bridge overpass 2.

If the lowest height of the bridge 2 is greater than the maximum height of the vehicle 3a than data for the bridge 2 is simply stored in memory 434 of the receiver unit 4a at step 516. If the lowest height of the bridge 2 is less than the maximum height of the vehicle 3a than the warning system is activated at step 514. The warning system may include a visual alarm, such as blinking or flashing displays 109 and/or 110 of FIG. 3 or may include an audible alarm, such as an audible message or alarm through speaker 432 shown in FIG. 6.

The speaker 432 may be a PKB8-4AO piezo-electric alarm-encased with internal frequency, 70/100/12 decibels/centimeters/Volts, 3.8 Kilohertz, 13/12 milliamps/Volts, 3.0 Volts. The audio warning strength level maybe turned off or adjusted by an operator of receiver unit 4a using the intensity control knob 433. The intensity control knob 433 may be a 3329H-1-101, ¼″ round single turn, trimmer or potentiometer.

The vehicle maximum height and bridge information could be projected by the projector 430 onto a portion of a windshield of the vehicle 3a that would not distract the attention of a driver from driving. The projector 430 may be actuated by the external switch 431. The microprocessor unit 426 may further analyze and stores information concerning many different bridges, bridge overpasses, or other obstacles, onto the memory device 434. The memory device 434 may be a S628512-7OLL, 512K×8 low power 32 pin Plastic Dual-In-Line Package (PDIP). At the end of a trip, data collected concerning such bridges, bridge overpasses, or other obstacles can be downloaded to the external data storage 435 by means of physical connection via a serial or a parallel port or wireless communication.

The method shown by FIG. 7 may begin as soon as a vehicle ignition for the vehicle 3a is turned on, since the receiver unit 4a is typically coupled to the vehicle electrical system as described. After the operator enters the vehicle maximum height at step 504 into the receiver unit 4a the method implemented by microprocessor 426 polls and starts sensing, i.e. is capable of receiving and processing signal from the transmitter 5. Once the receiver unit 4a receives the signal from the transmitter 5, including bridge information, such as for bridge 2, and then decodes the signal, the bridge information is then displayed on the front panel LCD display 110. The microprocessor unit 426 would then make a height comparison to determine if the warning system should be activated according to the method shown in FIG. 7. In either case, the bridge information is then stored in the memory 434 and sensing would begin again until the operator completes the trip.

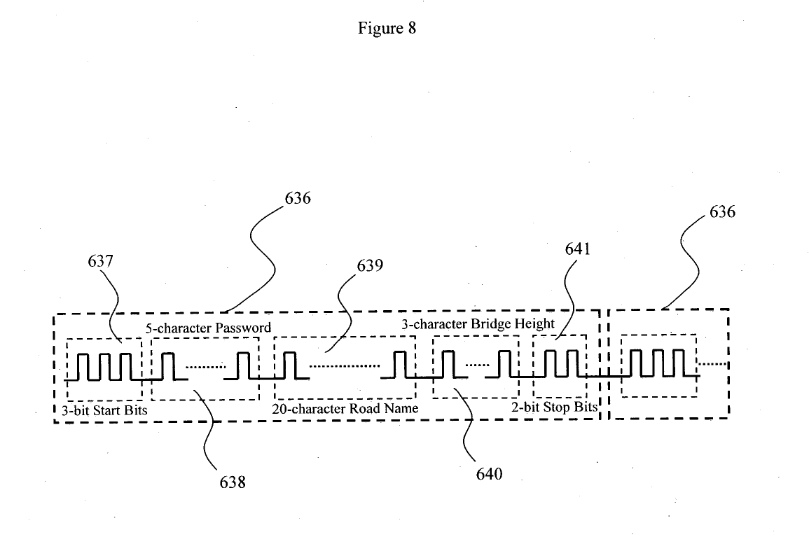

FIG. 8 shows a digital encoded information code, signal, or string 636 which may be transmitted as a part of a signal, which includes obstacle information, sent by transmitter 5. Each alphanumeric character provided for bridge or other obstacle information in the signal transmitted by the transmitter 5 is typically comprised of eight binary bits. Each alphanumeric character typically corresponds to a standard American Standard Code for Information Interchange (ASCII) code. The string 636 shown in FIG. 8 begins with 3 start bits 637) and then a five character password code 638). The bridge's information would typically be comprised of a string or code 639 twenty characters including space symbol for the road name that leads to the bridge or where the bridge is located, and a string or code 640 with three characters for the bridge height in feet and inches. The information string 636 ends with two stop bits before the whole string 636 is transmitted again. The transmitter 5 typically repeatedly transmits the string 636.

The system of one or more embodiments of the present invention is not confined to only vehicles such as cars, trucks, sport utility vehicles, vans, but can be employed to advantage in naval or marine vehicles. One possible application is to avoid collision of the boats with the dock or port sides during docking due to dock's width constraint. The present invention may also be employed to alert drivers of vehicles in the area of street and freeway intersections of any emergency vehicle activities, highway construction sites, or roadway flooding. In these applications, the transmitter 5 would be located in each of the emergency vehicle or construction vehicles, and the receiver unit 4a would be located in other vehicles on the roadway. When needed and in use, the operator of these emergency or construction vehicles would simply activate the transmitter 5 mounted in these vehicle to broadcast the preset information out i.e. ambulance, fire, construction, floods warning, etc. The transmitted information would be picked up by other drivers equipped with a receiver unit similar to or identical to receiver unit 4a mounted in their vehicle, in the vicinity of the two to five miles dynamic radial range.

The invention system can be also employed in freeway weighing station, where the transmitter 5 may be located at each weighting station and setup to broadcast the information that the weighing station is open and all trucks must enter the weighing station for inspection to every receiver unit similar to receiver unit 4a. In residential areas, where large trucks are prohibited to enter or travel through it, the transmitter 5 can be setup to broadcast this information several miles ahead of it to inform the operator equipped with receiver 4a unit. The transmitter 5 can also be setup near a tunnel entrance to transmit the tunnel entrance height and prohibited cargo list to the receiver unit 4a to warn an operator. Finally, the transmitter 5 can be setup near a bridge to transmit the bridge maximum allowable vehicle weight information to the receiver unit 4 to caution the operator.

The circuitry of the transmitter (5) and the receiver 4a has been especially designed to operate reliably in a roadway environment where there is an enormous amount of electrical noise and interference. The continuous repeated transmissions by transmitter 5 of the coded signal or data string shown by FIG. 8 ensures that the signal will reach each vehicle, such as vehicles 3a and 3b, even if blocked by another vehicle, trees or in a dip or curve on the road for part of the transmission period. The repeated transmission also compensates for the fact that engine electrical noise may distort or destroy one or more of the repetitions.

The password codes can be changed as needed, by a licensed party. This will help prevent sabotage by possible use of pirate transmitters attempting to duplicate transmitter 5 or pirate receiver units attempting to duplicate receiver unit 4a in the market.

The displays 109 and 110 shown in FIG. 3 may have different colored backgrounds or backlighting. For example display 109 may have a red colored background or backlighting and display 110 may have a green colored background or backlighting. The displays 109 and 110 and/or their backlighting may be illuminated upon receiving a recognizable modulated digital coded signal from the transmitter 5. The receiver unit 4 may include reset circuitry 113 as in FIG. 3 and an actuator switch, such as 115 shown in FIG. 3, operable by the operator to turn off an audio warning, concerning a vehicle maximum height being greater than a bridge height, following the warning's recognition.

The projector 108 may and the switch 116 may be operable by the operator to turn on the information projection on a windshield of the vehicle in a dim light condition, such as for nighttime driving.

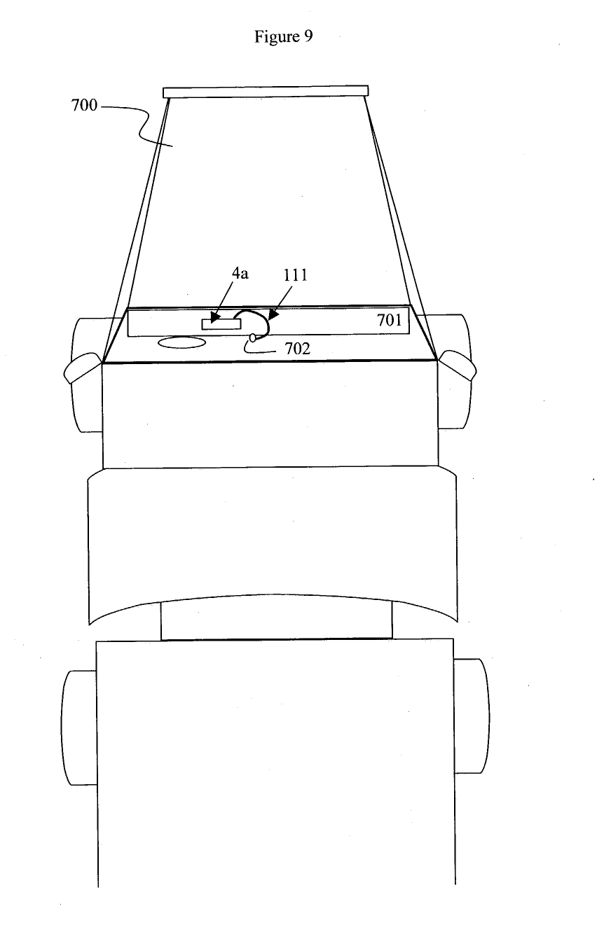

FIG. 9 shows the top view of a portion of a semi-truck 700 mounted with receiver unit 4a. The receiver unit 4a may be mounted and located on a dashboard 701 of the semi-truck vehicle 700. The components of receiver unit 4a may include components previously shown in FIG. 3 and are omitted in FIG. 9 to simplify description. The appropriate location of the receiver unit 4a should provide a maximum viewing angle of the receiver LCD displays 109 and 110 to the operator and the image projection from the receiver projector 108 on the windshield The maximum viewing angle means that the LCD displays 109 and 110 are in plain view i.e. in front of the operator of the vehicle 700 without obstruction. Also, included in FIG. 9 is the power supply cable 111 for the receiver unit 4a connected to a conventional vehicle cigarette lighter adapter 702.

Although the invention has been described by reference to particular illustrative embodiments thereof, many changes and modifications of the invention may become apparent to those skilled, in the art without departing from the spirit and scope of the invention. It is therefore intended to include within this patent all such changes and modifications as may reasonably and properly be included within the scope of the present invention's contribution to the art.

We claim:

1. An apparatus comprising
A receiver unit comprised of a processor and an indicator;
wherein the receiver unit can receive a signal from a transmitter;
wherein the signal includes information about an obstacle on a transportation route;
and wherein the processor obtains from the signal the information about the obstacle, and the processor causes the indicator to provide an indication relating to the information about the obstacle.

2. The apparatus of claim 1 wherein
the obstacle is a bridge overpass.

3. The apparatus of claim 1 wherein
the indicator is a visual display.

4. The apparatus of claim 1 wherein
the indicator is an audible alarm.

5. The apparatus of claim 2 wherein
the indicator is a visual display and
the information provided about the obstacle is the lowest height of the bridge overpass.

6. The apparatus of claim 1 wherein
the receiver unit includes a memory in which is stored a maximum height of a vehicle in which the receiver unit is located.

7. The apparatus of claim 6 further comprising
a visual display, which displays the maximum height of the vehicle.

8. The apparatus of claim 1 wherein
the receiver unit includes a keypad, which can be used to enter the maximum height of a vehicle in which the receiver unit is located.

9. The apparatus of claim 8 wherein
the receiver unit includes a memory in which is stored a maximum height of a vehicle in which the receiver unit is located.

10. The apparatus of claim 1 wherein
the information provided about the obstacle includes the location of the obstacle.

11. The apparatus of claim 10 wherein
the location of the obstacle includes a street where the obstacle is located.

12. The apparatus of claim 1 wherein
the signal is comprised of a string of digital bits.

13. The apparatus of claim 12 wherein
the string of digital bits includes a string of start bits, a string of password bits, a string of location bits specifying the location of the obstacle, and a string of stop bits.

14. The apparatus of claim 13 wherein
the obstacle is a bridge and the string of digital bits includes a string of bridge height bits.

15. The apparatus of claim 1 wherein
the receiver unit includes means for mounting the receiving unit onto a dashboard of a vehicle.

16. The apparatus of claim 1 wherein
the receiver unit includes means for mounting the receiving unit onto an inner ceiling of a vehicle.

17. The apparatus of claim 2 wherein
the information about the bridge is a height of the bridge overpass;
and the processor compares a maximum height of a vehicle with the height of the bridge overpass;
and the processor causes the indicator to provide an indication when the maximum height of the vehicle is greater than the height of the bridge overpass.

18. The apparatus of claim 1 wherein
the receiver unit includes a demodulator;
wherein the signal received by the receiver unit is a modulated carrier signal and the demodulator demodulates the signal.

19. The apparatus of claim 1 wherein
the receiver unit includes a decoder; and
wherein the decoder decodes the signal with the use of a password.

20. An apparatus comprising
a transmitter, which transmits a signal, which includes information about an obstacle on a transportation route.

21. The apparatus of claim 20 wherein
the transmitter is permanently mounted at the location of the obstacle.

22. The apparatus of claim 21 wherein
the obstacle is a bridge.

23. The apparatus of claim 22 wherein
the information about the obstacle includes the height of the bridge.

24. The apparatus of claim 20 wherein
the transmitter repeatedly transmits the signal during a pre-determined transmission time.

25. A method comprising
obtaining a signal from a transmitter;
wherein the signal includes information about an obstacle on a transportation route;
and further comprising causing an indicator to provide an indication relating to the information about the obstacle.

26. The method of claim 25 wherein
the obstacle is a bridge overpass.

27. The method of claim 25 wherein
the indicator is a visual display.

28. The method of claim 25 wherein
the indicator is an audible alarm.

29. The method of claim 26 wherein
the indicator is a visual display and
the information provided about the obstacle is the lowest height of the bridge overpass.

30. The method of claim 25 further comprising
storing in memory a maximum height of a vehicle.

31. The method of claim 30 further comprising
displaying the maximum height of the vehicle.

32. The method of claim 25 further comprising
receiving via a keypad a maximum height of a vehicle.

32. The method of claim 25 wherein
the information provided about the obstacle includes the location of the obstacle.

33. The method of claim 32 wherein
the location of the obstacle includes a street where the obstacle is located.

34. The method of claim 25 wherein
the signal is comprised of a string of digital bits.

35. The method of claim 25 wherein
the obstacle is a bridge, the information about the obstacle is a height of the bridge;
further comprising comparing the maximum height of a vehicle with the height of the bridge;
and causing the indicator to provide an indication when the maximum height of the vehicle is greater than the height of the bridge.

36. The method of claim 25 further comprising
demodulating the signal to obtain the information about the obstacle.

37. The method of claim 25 further comprising
wherein the decoding the signal with the use of a password.

38. A method comprising
transmitting a signal, which includes information about an obstacle on a transportation route.

39. The method of claim 38 further comprising
permanently mounting a transmitter at the location of the obstacle and using the transmitter to transmit the signal.

40. The method of claim 39 wherein
the obstacle is a bridge.

41. The method of claim 40 wherein
the information about the obstacle includes the height of the bridge.

42. The method of claim 38 wherein
the transmitter repeatedly transmits the signal during a pre-determined transmission time.
